(19) United States
(12) Patent Application Publication
(10) Pub. No.: US 2010/0250427 A1
(43) Pub. Date: Sep. 30, 2010

(54) MANAGING SALES OF SECURITIES AND FINANCIAL DATA

(75) Inventors: Jeffrey Folger, Brooklyn, NY (US); Bernard Edelstein, Brooklyn, NY (US)

Correspondence Address: KATTEN MUCHIN ROSENMAN LLP, 575 MADISON AVENUE, NEW YORK, NY, 10022-2585, US

(73) Assignee: SECURITIES REPORTS STREAMLINED LLC, New York, NY (US)

(21) Appl. No.: 12/600,105

(22) PCT Filed: May 16, 2008
(86) PCT No.: PCT/US08/63925

§ 371 Date: Nov. 13, 2009

Related U.S. Application Data
(60) Provisional application No. 60/938,750, filed on May 18, 2007.

(51) Int. Cl. G06Q 40/00; G06F 3/048

(52) U.S. Cl. 705/37; 705/35; 715/853

(57) ABSTRACT

A computer program stored on a computer readable recording medium usable for the sale of securities. The computer program facilitating the transfer of documentation between a shareholder, a broker, a transfer agent, the company and legal review. The computer program providing remote access to centralized data provided by each of the participants in the sale to promote the speed of the sale and guarantee the regulatory propriety.

### BACKGROUND OF THE INVENTION

1. Field of the Invention

The present invention relates to a package of transaction services for financial securities and the management of financial and other data, and more particularly to a web-based system that manages designated aspects of sales of these securities under Rule 144 of the Securities Act of 1933 and in registered transactions reducing the overall costs of essential securities transactions by reducing both the cost of transmission, the cost of reporting and reducing delay, as well as enhancing the quality of the transaction.

2. Description of the Related Art

One aspect of the present invention is directed to management and sale of securities that were registered for public sale under the Securities Act of 1933 and also to “control” securities or “restricted” securities. Control securities are securities that are owned by directors or officers of an issuer, whether or not registered. Restricted securities are securities that were acquired in a transaction or chain of transactions that did not involve a registered public offering.

For sales of registered securities the main task of the participants in a transaction is to assure that the appropriate registration statement is in effect, that appropriate stock certificates have been presented and that requisite records are accurately maintained. Another task for participants in a transaction for the sales of both control securities and restricted securities is to ensure that 17 CFR 230.144 (Rule 144) applies.

Rule 144 applies if the certain basic conditions are met including:
i) Adequate current public information with respect to the issuer is available;
ii) If the securities are restricted securities, a one-year holding period has been satisfied; and
iii) The amount of securities sold by an affiliate in each three-month period does not exceed the greater of:
   (a) 1% of the outstanding securities of that class or
   (b) the average weekly reported exchange volume of trading during the four-week period prior to the date of the Form 144 notice referred to below.

Other requirements of Rule 144 include ensuring that the sales are made in either ordinary brokerage transactions or directly with a market maker. And except for small sales (not more than 5,000 shares or $50,000 aggregate sales price in the three-month period), the seller files a notice of sale on Form 144 with the SEC and, in the case of listed securities, the principal stock exchange.

Another requirement is the availability of designated current information about the issuer.

Restricted securities of a reporting company must be fully paid for and held for 6 months year before they can be sold under Rule 144. Restricted securities of a non-reporting company must be fully paid for and held for one year before they can be sold under Rule 144. A private sale of restricted or control securities will start a new holding period if the seller is an affiliate of the issuer. No new holding period begins—the prior holding period is “tacked”—if the seller is not an affiliate of the issuer. Tacking is permitted for stock dividends and stock splits, recapitalizations, or conversions of convertible securities if the only consideration surrendered upon conversion consists of other securities of the same issuer. Tacking is also permitted for certain bona fide pledgees, donees of gifts and trusts.

There are limitations on the amount of securities that can be sold. These limitations include a limitation on the amount of securities which may be sold pursuant to the Rule in any three-month period. This is limited to the greater of 1% of the outstanding securities of the class being sold or the average weekly volume of that class for the four calendar weeks prior to the filing of the notice of sale. Sales by persons acting in concert are aggregated.

As described above, sales under Rule 144 can be made in either brokers' transactions (as defined) or transactions directly with “a market maker.” Rule 144 provides that the broker should obtain and retain a copy of the notice of sale and make a reasonable inquiry to ascertain whether the seller is engaged in a distribution. Typical inquiry includes the following:
1. The length of time the securities have been held by the person for whose account they are to be sold:
2. The nature of the transaction in which the securities were acquired by such person;
3. The amount of securities of the same class sold during the past three months by all persons whose sales are required to be aggregated;
4. Whether such person intends to sell additional securities of the same class through any other means;
5. Whether such person has solicited or made any arrangement for the solicitation of buy orders in connection with the proposed sale of securities; and
6. The number of shares or other units of the class outstanding, or the relevant trading volume.

There are also provisions requiring a Notice of Proposed Sale. Concurrently with either the placing of the sell order with the broker or the execution of the sale directly with a market maker, the seller, if required under Rule 144, must appropriately file a notice of sale on Form 144. The Form 144 cannot specify an amount of listed securities to be sold in excess of the amount limitation determined as of the date of filing the Form. If thereafter the average trading increases, the seller may re-compute the volume limitation (excluding the seller's sales during the new period) and file an amended Form 144 locking in the new volume limitation.

After six months (or a year in the event the company is a non-reporting company), Rule 144(b)(i) ceases to place restrictions on sale. Rule 144 provides that restricted securities that have been held for the requisite period of time may be sold without complying with any of the requirements of Rule 144, provided the holder is not an affiliate and has not been an affiliate for three months prior to the sale. Tacking is permitted to satisfy the holding period.

Other basic requirements for consideration in the sale of control and restricted securities include so called “Section 16b” requirements that arise under Section 16(b) of the Securities Exchange Act of 1934 that restrict purchases by an insider within six months of a sale by the insider, and sales by an insider within six months of a purchase by the insider. Also, many public companies impose general blackout periods during each year when no stock may be sold by insiders, as well as specific blackout periods in relation to unusual events. Selling shareholders may also have signed lock-up letters that limit sales by special agreement with the issuer.

In addition to the basic timing requirements discussed above, that are generally attendant to financial transactions that involve significant sums, time pressures for security clearances are often amplified by “T+3” rules. These rules require that most transfers must be settled with clean stock certificates within three days after the trade. Failure to comply with these rules can result in the cancellation of trades, with significant monetary loss, as well as potential liability under the 16(b) rules described earlier, and the violation of other legal requirements.

Currently to sell a registered security, the issuer registers the resale of particular classes of securities for the specified shareholders listed on the registration statement. Securities registered by the registration statement are typically legended with a certificate putting the transfer agent on notice that the securities covered by the registration statement cannot be freely traded without the prior approval of the issuer. In most cases, the transfer agent will require the issuer's attorney to opine by written opinion that the legend on the securities can be removed in the hands of the buying security holder. The transfer agent will also typically require that the issuer approve of the issuance of any securities, including issuances upon conversion or exercise of securities, and may further require an attorney's opinion that opines to the validity of the particular issuance. Shareholders, whether directly or through the broker, periodically request that the issuer convert or exercise securities held by the shareholder and covered by a registration statement. The issuer monitors and tracks these conversions and exercises in order to maintain a list of the current balance of securities covered by the registration statement. Shareholders, whether directly or through the broker, periodically request that the issuer remove the legends from the securities held by the shareholder and covered by the shareholder so that such shareholder can transfer such security free of any legends. The issuer monitors and tracks these conversions and exercises in order to maintain a list of the current balance of securities covered by the registration statement.

Requests by the shareholder, whether for conversion, exercise or legend removal, are typically accompanied by various documents that the issuer and the transfer agent require in order to process the requests. Attorney opinions may also be required. The entire process relating to the exercise, conversion or legend removal request is a manually intensive process. Documents are generated on individual personal computers and then sent by facsimile, originals following by mail, to appropriate parties. The issuer tracks the outstanding security balances of the selling shareholder's position in the registration statement by hand or on a personal computer accessible, for the most part, to the individual charged with the task of updating the shareholder table balances. Communications between all the parties, including the shareholder, broker, issuer, attorney and transfer agent is by phone or e-mail, a process that often results in long time delays and puts the shareholder at risk of a slide in the stock price.

There are similar and certainly no less confusing and inefficient practices currently used for the sale of Restricted and Control Securities. The selling shareholder frequently has no legal knowledge on whether or not his shares are currently sellable into the public markets or the extent to which his shares are sellable into the public market. The function of the selling shareholder is to provide a stock certificate to his or her broker, to reflect ownership of the shares proposed to be sold, and to forwarding to the transfer agent to effectuate transfer to the buyer once the sale is effected. A copy of the stock certificate is forwarded to the issuer and its counsel, as an indicator of when the shares were acquired for purposes of determining the extent if any to which the holding period requirement has been satisfied for sales under Rule 144.

The broker commonly assumes the responsibility of and for the inquiry described above under “Manner of Sale” including a determination of whether the selling shareholder or his predecessor is an affiliate, which in turn affects whether Rule 144(b)(i) is available for the sale, and whether the holding period of the predecessor may be added to the holding period for the selling shareholder. The broker also calculates the recent average trading volume to compute any limitations on the maximum number of shares that may be sold, and compiles a list of any sales made by the selling shareholder within the past 90 days, since these sales are counted against volume limits.

The broker is also responsible for preparation of representation letters. These letters include a letter by the selling shareholder on whether the holding period for 144 sales has been met and whether the holding period for 144(b)(i) sales have also been met. Another representation letter is by the broker itself that it has used or will use ordinary broker's transactions, as defined in the rule, in connection with the sales or proposed sales of the shares. Finally, the broker is responsible for preparation and completion of Form 144.

The issuer controls the transfer process through its relationship with the transfer agent and its counsel. It is the issuer's responsibility, generally exercised by its counsel, to confirm that all legal requirements are met before the transfer agent proceeds with the issuance of a new stock certificate to the buyer or to the buying broker.

The SEC looks to counsel for the issuer to police the transaction, and to ensure to the transfer agent by counsel's opinion that all representation letters have been received, the form 144 has been properly completed and mailed, all relevant affiliates have been identified and that their status has been properly reflected in the proposed transaction, and all regulatory requirements have been satisfied.

As is apparent from the foregoing, the sale of registered and control and registered securities is a convoluted process requiring many people coordinating their activities in order to meet the regulatory requirements and effectuate a sale. Accordingly, a more streamlined and effective process is needed to enable these sales to be effectuated in a more straightforward manner, enable greater oversight and accountability during the process, and to enable a one-stop shopping environment for the sale and management of these securities.

### BRIEF DESCRIPTION OF THE DRAWINGS

FIG. 1 is a screen shot showing an alerts dashboard according to one aspect of the present invention;

FIG. 2 is a screen shot showing a tacking scenario according to one aspect of the present invention;

FIG. 3 is a screen shot showing a documents vault according to one aspect of the present invention;

FIG. 4 is a screen shot of a Rule 144 form generated according to one aspect of the present invention;

FIG. 5 is a screen shot of templates generated according to one aspect of the present invention;

FIG. 6 is a screen shot of a checklist generated according to one aspect of the present invention;

FIG. 7 is a screen shot of a registration statement according to one aspect of the present invention;

FIG. 8a is a first type of report according to one aspect of the present invention;

FIG. 8b is a lower level report according to one aspect of the present invention;

FIGS. 9a-9o detail a securities sale procedure performed on a computer application according one aspect of the present invention;

FIGS. 10a-10c depict a process for generating a hierarchical tree for data such that reports can be generated at each level for review of differing levels of data;

FIG. 11 is a simplified schematic of a computer network system according to one aspect of the present invention.

### SUMMARY OF THE INVENTION

One aspect of the present invention is directed to a system that incorporates functionalities that address various complex corporate and legal security related processes that would significantly benefit from creative end-to-end systemization. For example, the invention provides corporate management with dynamic information on shareholder positional data in various corporate securities. The system also includes facilities for web-based service data feeds, selected process flow integration, and methods for shared security access between participants.

According to one embodiment, the system prepares and routes required regulatory forms, representation letters, and legal opinions. The system also orchestrates flexible workflow between transaction participants (brokers, company administrators, lawyers, transfer agents, and shareholders). In the system users are assigned roles that drive access privileges, system menus and workflow. The users communicate via secure internally generated alerts and messages, and optionally can include links to conventional e-mail. The system is centrally maintained on a web server and Individual users require no infrastructure other than a web browser.

A system administrator oversees the system flow, control user account access, manage global tables, and provide for overall security and system support. One aspect of the present invention is the inclusion of Secure Sockets Layer (SSL) technology and provides rigorous security at all levels.

### DETAILED DESCRIPTION

One aspect of the present invention is a system and method that addresses the fundamental disorganization in the current clearance process—excessive reliance on cut and paste use of office and manual intervention—with practical automation that enhances the process. This system is a web based computer application, of the sort hosted by at least one server or computer readable recording medium stored network node and accessible to each of the participants in the securities sale process.

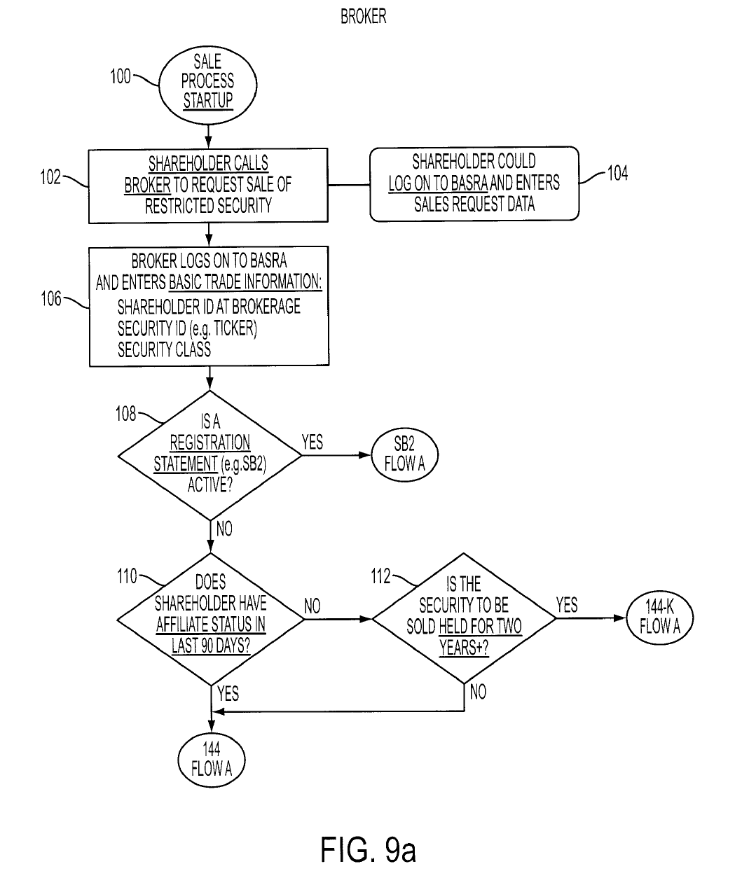

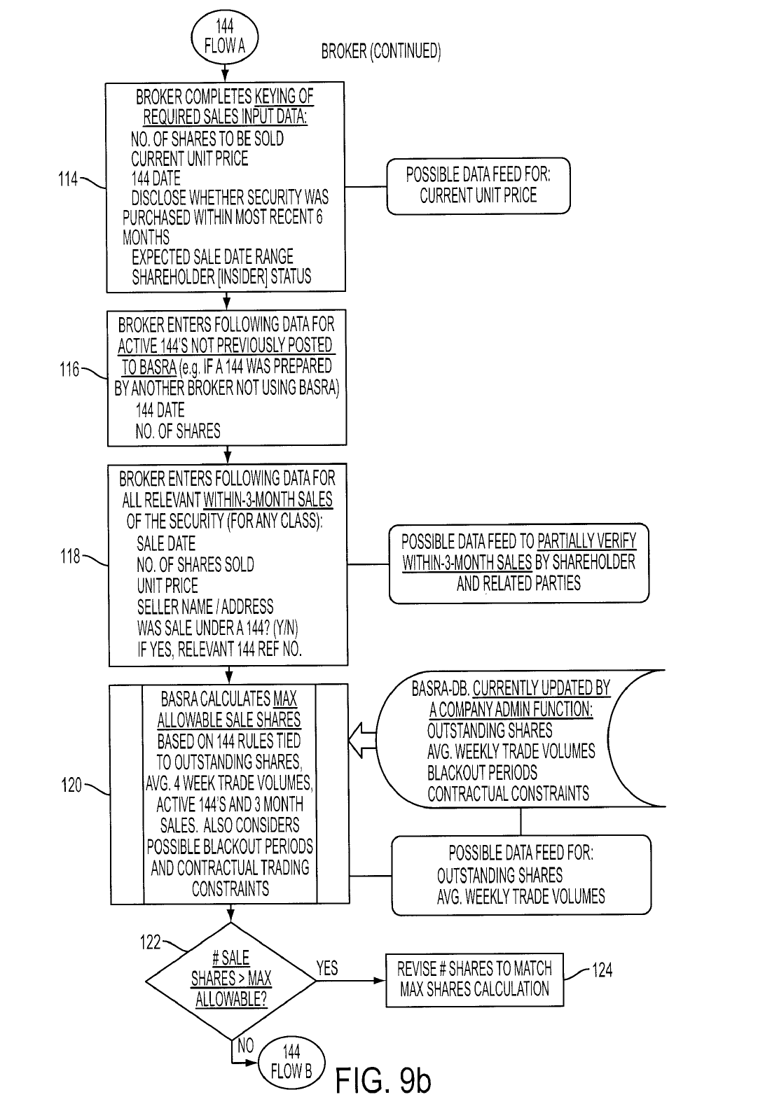

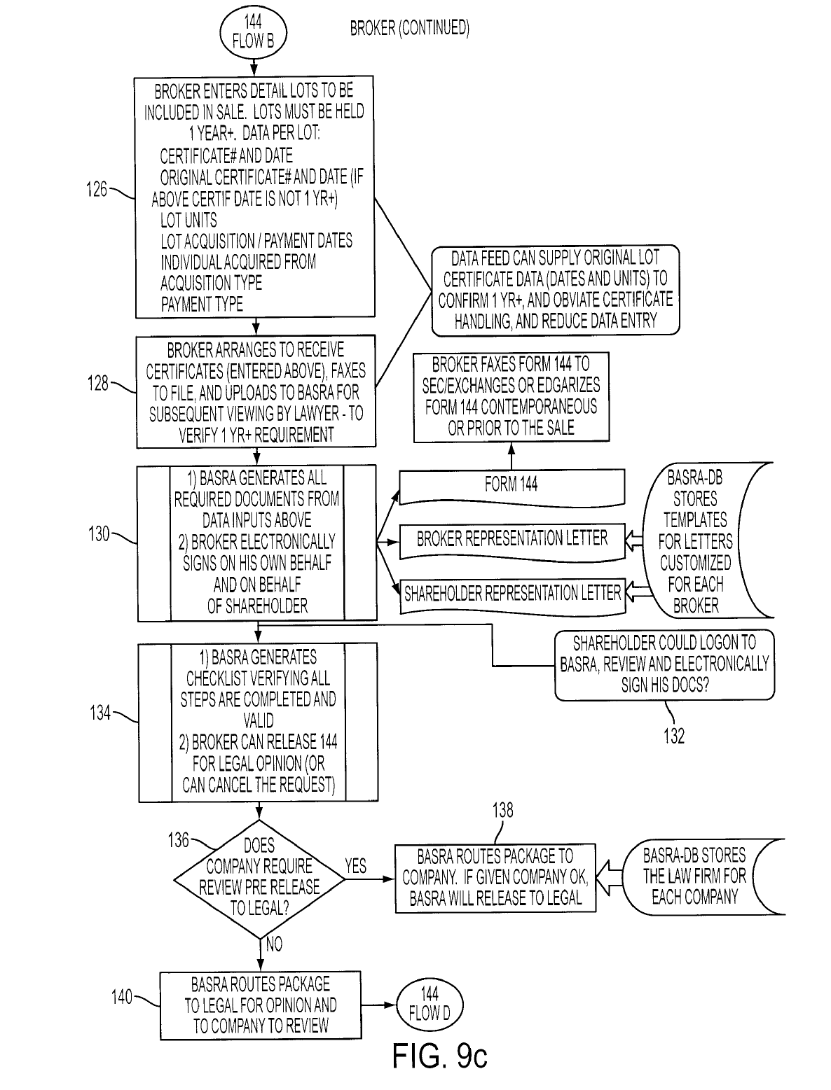

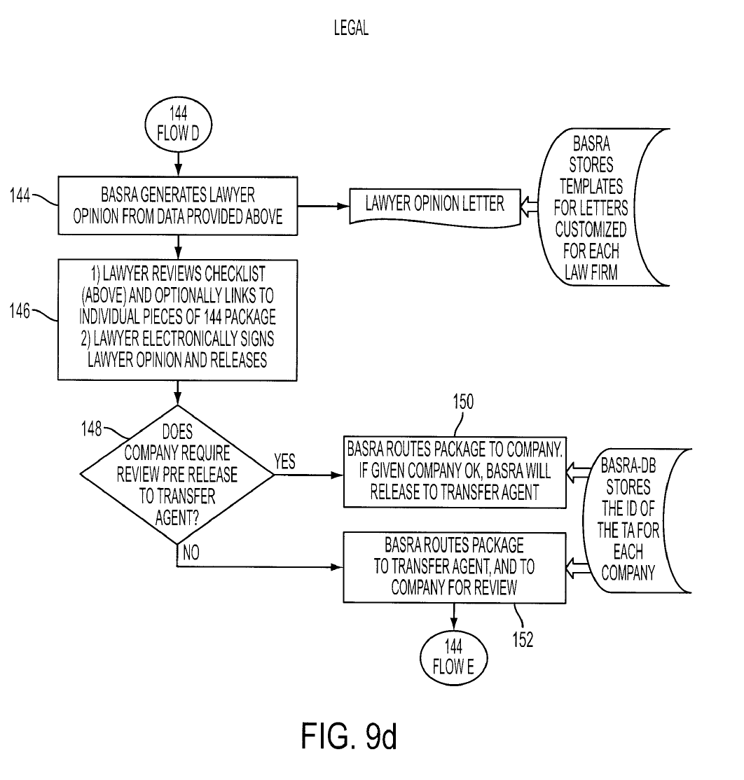

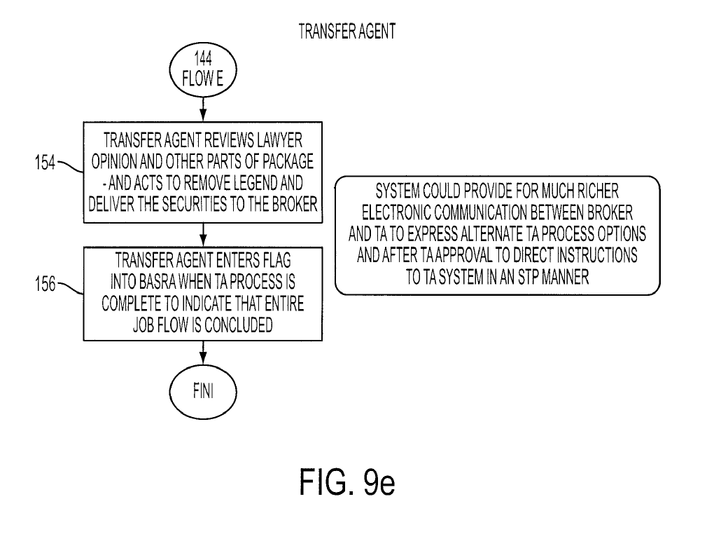

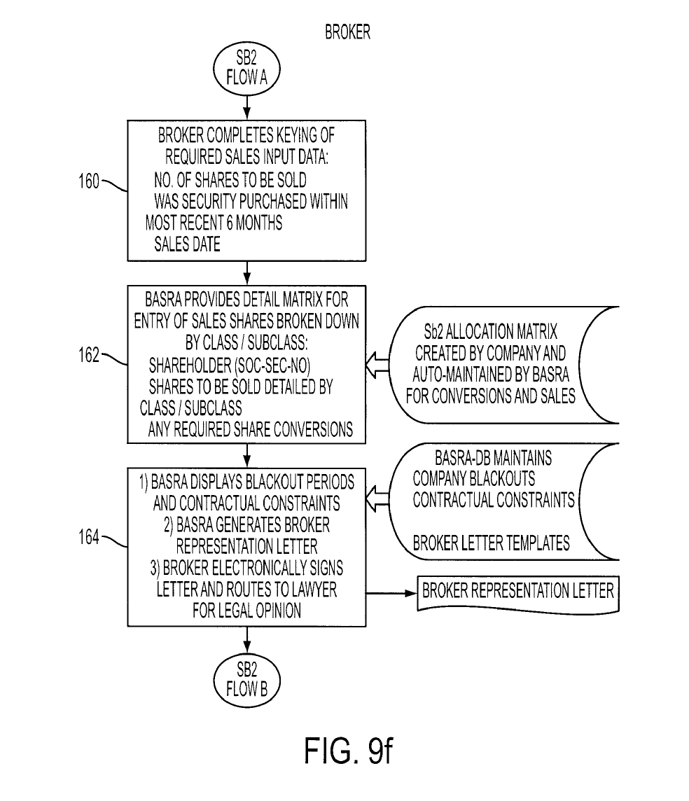

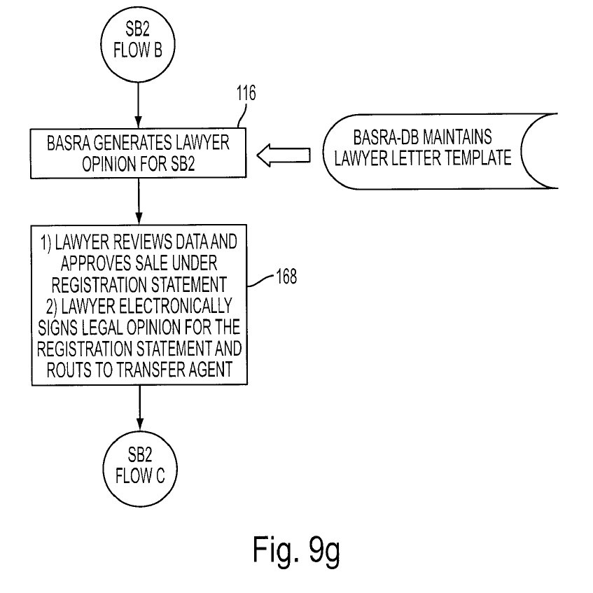

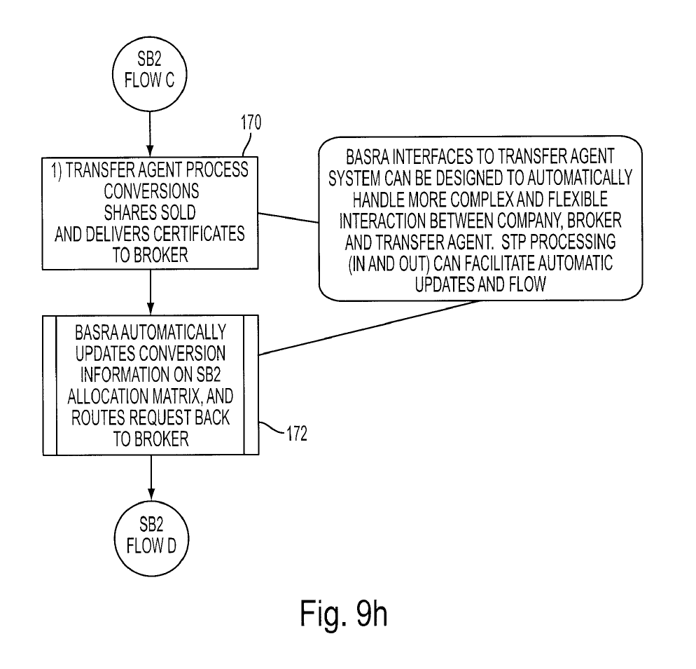

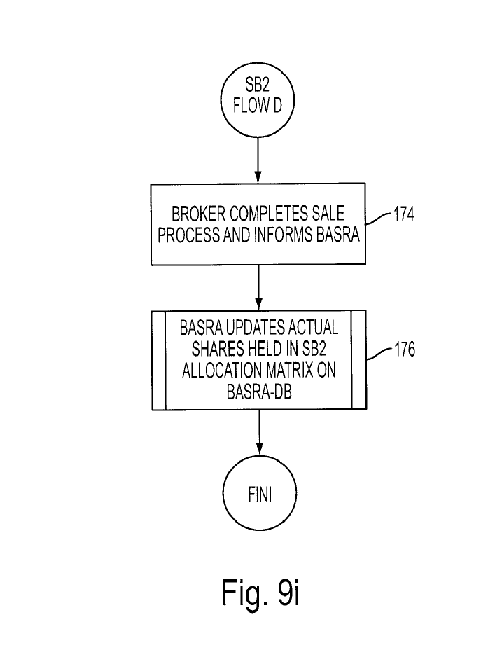

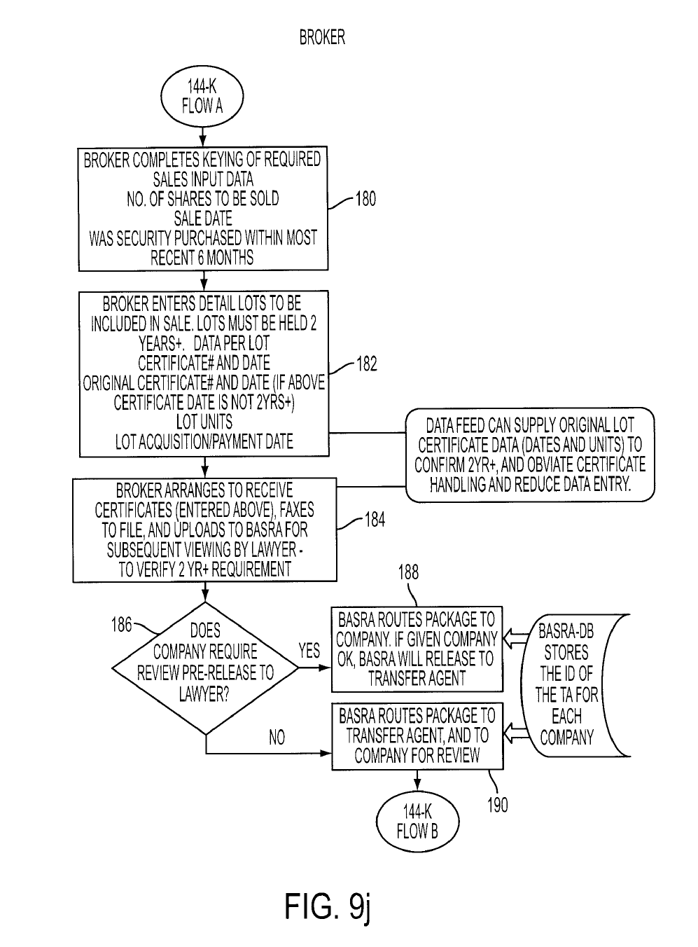

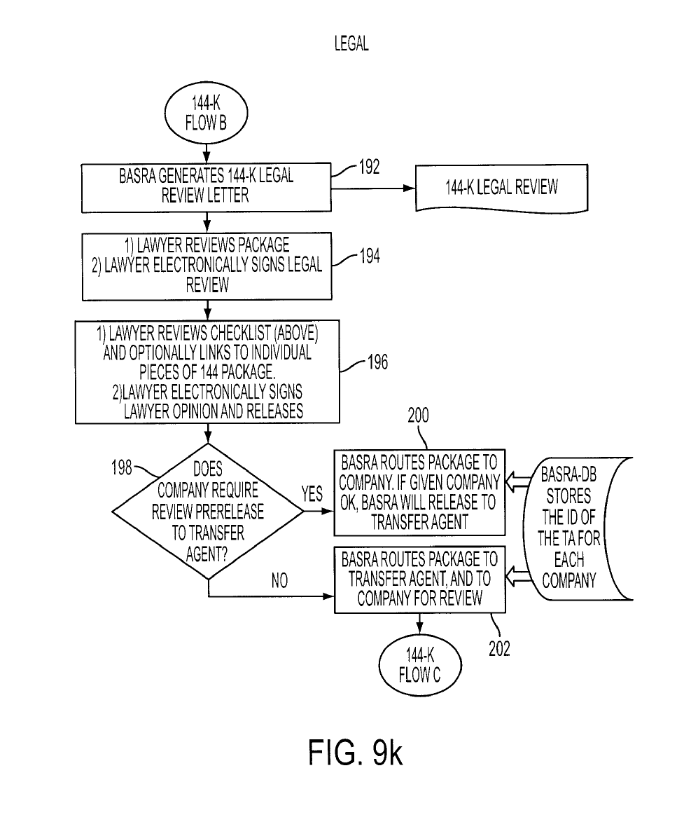

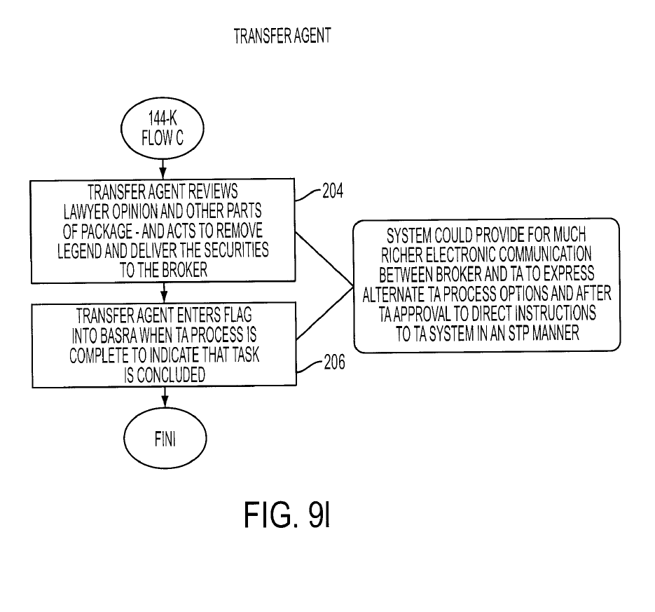

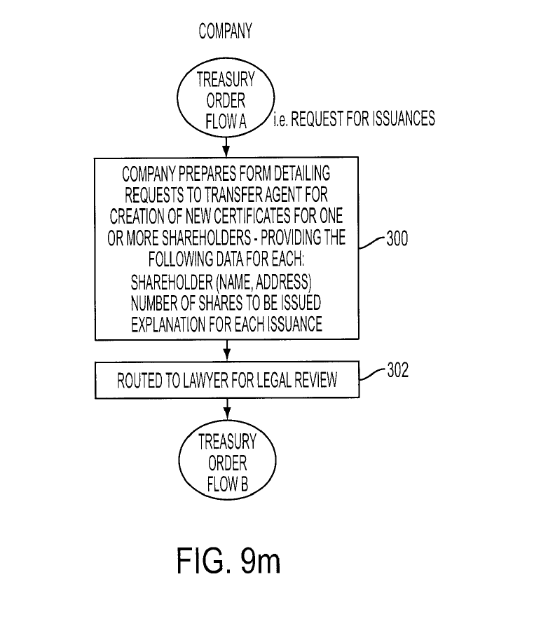

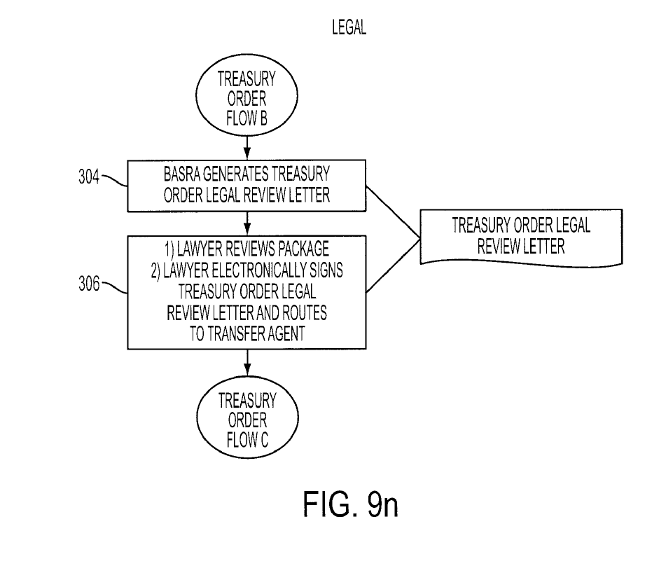

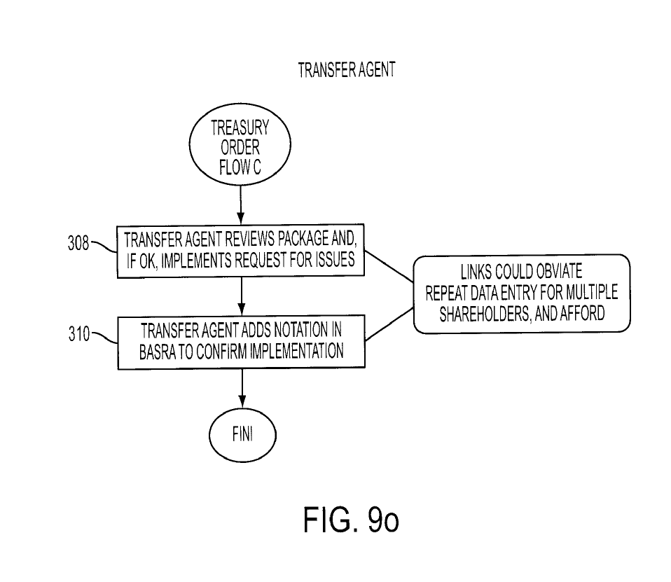

FIGS. 9a-9o show a flow chart detailing each step in this process operating on a system called SRSrun (also referred to as BASRA) which stands for Securities Reports Streamlined. FIG. 9a begins with a startup at step 100. As part of the start up the shareholder could either call their broker to request a sale at step 102, or log on themselves to the SRSrun system to enter a sales request 104. Either way, the broker longs on at step 106 and enters the basic trade information. By entering this information, the SRSrun system begins to ask questions.

The first question SRSrun asks of the broker is whether there is a registration statement at step 108. If the answer is yes then SRSrun directs the system to the procedures shown in FIGS. 9f-9i, if not then SRSrun asks whether the shareholder had affiliate status in the last 90 days at step 110. If the answer is yes, then SRSrun directs the broker to the actions shown on FIGS. 9b-9e, but if no then SRSrun asks whether the security has been held for two or more years in question 112. If the security has been held for two or more years then SRSrun directs the user to the procedures outlined in FIGS. 9j-9l.

The following are the procedures in the automated SRSrun system of the present invention for a sale under Rule 144 shown in FIGS. 9b-9e. In FIG. 9b at step 114, the broker is asked to key in the required sales input data, some of which may be provided via an external data feed such as the current price of the security. In the event the security had never been posted within the SRSrun system previously, the broker is required to provide additional information such as the 144 date and the number of shares in step 116. With this additional information, the broker is then required to enter the information regarding relevant sales within the past three-months in step 118. Again some of this information may be available as part of a data feed from either external sources, or other information already stored within the SRSrun databases. This information may be used then to automatically populate the information request screens within the SRSrun system.

Using all this information either provided by the broker or gathered from other sources either external to SRSrun or already stored within the SRSrun databases, the system is able to calculate a maximum number of shares that can be sold at step 120. Next in step 122 a determination is made whether the number of shares offered for sale by the shareholder exceeds a maximum number allowed to be sold. If the answer is yes, then SRSrun automatically revises the number of shares to be sold to the maximum number in step 124 and SRSrun proceeds to step 126, if the answer is no then SRSrun also proceeds to step 126.

In step 126, the broker is again required to provide detail on the transaction. Here the broker must provide detail regarding the lots of securities to be included in the sale. Again some of this data may be provided and the data fields populated from sources within the SRSrun databases or with connection to external sources. In step 128, the broker arranges to receive the certificates entered in step 126, and uploads them to SRSrun for viewing later by attorneys to verify the one year requirement. Once complete, at step 130 SRSrun automatically generates all of the required documents including the Form 144, which is sent on to either the SEC/Exchanges, a broker representation letter which may be based on a template stored in the SRSrun database and customized for the broker. Finally SRSrun generates a shareholder representation letter which again may be based on a template customized for the shareholder. The broker then can affix his own signature as well as that of the shareholder. The shareholder could also affix his signature himself by logging on to the SRSrun system as in step 132.

After the forms have been generated, SRSrun generates a checklist verifying all the steps are complete and valid in step 134. If this is the case, then the system determines whether the company whose securities are being sold requires a review prior to release to counsel for review in step 136. If the company does require a review, SRSrun electronically routes the document package to the company for review in step 138. Once the company provides its approval of the documentation and indicates so through SRSrun, or if no pre-review is necessary, the SRSrun system electronically releases the package to counsel for review and opinion in step 140. SRSrun stores in its database the name of the law firm or corporate legal department to whom the package is to be sent for review and opinion.

Once the package of documents is released by SRSrun to the attorneys, SRSrun generates a legal opinion at step 144 based on the data provided and stored in the SRSrun databases. Again the legal opinion is based on templates stored in the SRSrun databases and optimized for the specific security and attorneys. In step 146, the attorneys review the opinion and any of the necessary underlying documents to verify the opinion and then signs the opinion. Once the signature is attached SRSrun determines in step 148 whether the company requires review of the opinion prior release to a transfer agent. If the company requires review, the entire packet is sent to the company in step 150. Once approval is given by the company, SRSrun forwards the package to the transfer agent. If no pre-approval is necessary the package can be sent simultaneously to the company and the transfer agent in step 152.

The transfer agent then receives the package and reviews the opinion from the attorneys and other parts of the package in step 154. The transfer agent, if everything in the packet is in accordance with the rules, removes the legend from the securities and delivers them to the broker for sale. The transfer agent then indicates that work flow is complete in SRSrun, thus all interested parties are aware of the status of that sale.

If in FIG. 9a, there had been a registration statement or SB2 form active, SRSrun would direct the work flow to step 160 on FIG. 9f, where the Broker completes keying in the required sales input data. SRSrun then, pulling data from its databases provides a detailed SB2 matrix for entry of sales shares broken down by class and subclass in step 162. The system then in step 164 displays for the broker's review any blackout periods and generates a broker representation letter to which the broker adds his signature following review and then forwards it to legal for review. As before, the broker representation letter is generated from templates stored in the SRSrun databases and customized for the broker and the specific securities.

Once the packet is forwarded to the attorneys, SRSrun generates a legal opinion in step 166. This opinion is reviewed and approved by the attorneys after review of the opinion in step 168. The lawyer signs the opinion and forwards the packet to the transfer agent.

The transfer agent processes conversions and shares to be sold in step 170 and delivers the certificates to the broker. SRSrun then automatically updates conversion information in the SB2 allocation matrix stored in the SRSrun database and routes the information back to the broker in step 172. The broker then completes the sale in step 174 and SRSrun is informed and in turn updates in step 176 its allocation matrix to indicate the shares held in SB2 allocation matrix on the SRSrun database as shown in FIG. 9i.

Finally, if the security had been held for two years in step 112, then SRSrun forwards the process to step 180 in FIG. 9j, where the broker completes inputting of the required sales data. In step 182, the broker must enter details regarding the lots to be included in the sale. The SRSrun databases can again populate fields in this step to assist and confirm that certain lots of securities have in fact been held for two plus years. The broker then arrange to receive the certificates in step 184, and uploads them to SRSrun for subsequent viewing by the attorneys. If the company requires pre-release review in step 186, the package is forwarded to the company for review in step 188. If the company approves then the package is forwarded to the transfer agent. If no pre-release review is necessary in step 186, then the package is forwarded to the company and the transfer agent simultaneously in step 190.

SRSrun generates a Rule 144 legal review letter in step 192, which is generated using the information provided in the sale by the broker and formulated by templates stored in the SRSrun database. The lawyer reviews the package and any of the underlying documents in step 194. If the package meets his approval it meets his approval signs the letter and releases it in step 196. In step 198 SRSrun determines whether the company requires review before releasing to the transfer agent. If it does, then the package is forwarded to the company for review in step 200, and if it meets with their approval is forwarded to the transfer agent. If no pre-release review is necessary then the package is sent to the transfer agent and the company simultaneously for review in step 202.

In step 204, the transfer agent reviews the opinion letter and other parts of the package and if proper acts to remove the legend from the certificates and to deliver the securities to the broker. The transfer agent then using SRSrun indicates that all actions have been completed at step 206.

By these actions and using the automated web based system, each one of the parties described above is connected, they receive the proper documentation in the proper order, and if there is a delay, each party in the process understands where that delay is.

Similarly, SRSrun can be used by the companies to initiate the creation of new certificates through the transfer agents, as shown in FIGS. 9m-9o. In FIG. 9m at step 300 the company prepares a form, generated as part of SRSrun, for the creation of new certificates or new shareholders. This form is then forwarded for legal review in step 302. Upon receipt for legal review SRSrun generates a treasury order legal review letter in step 304. This review letter is then itself reviewed along with the other information forwarded by the company through SRSrun, electronically signed, and routed to the transfer agent in step 306. The transfer agent reviews the package and if all is in accordance with the rules, implements the request for issuing the certificates in step 308. The transfer agent also updates SRSrun to reflect the implementation, and the new shares are issued.

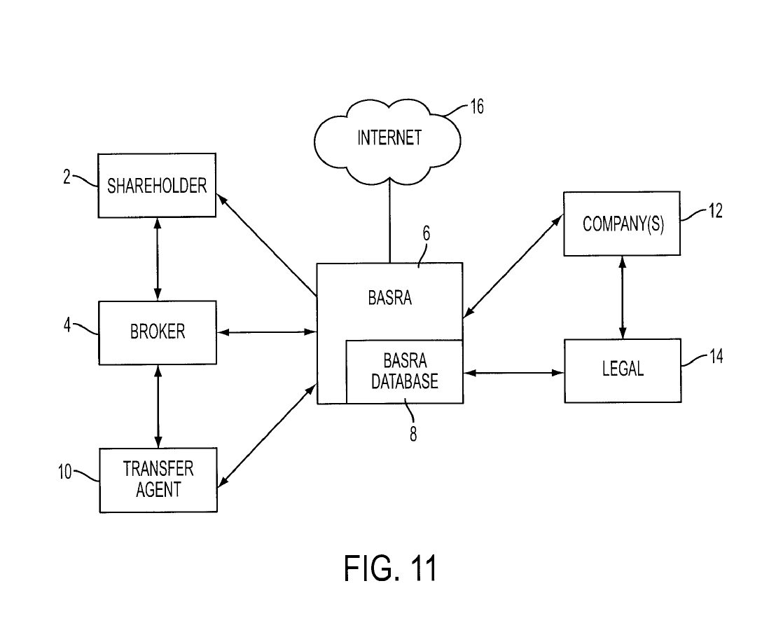

FIG. 11 shows a simplified schematic of the computer network on which the SRSrun system operates. In this network, the shareholders 2 are connected directly to the broker 4 and to the SRSrun system 6. The broker is connected to SRSrun and the transfer agent 10. The company(s) 12 and legal 14 are also connected to each other and to SRSrun. The SRSrun databases are housed within for example a server on which SRSrun operates and may be connected via the internet 16 other elements. Of course as this is a simplified system there may be additional communication routes other than those shown, and the participants themselves may connect to SRSrun through various internet based systems including but not limited to a virtual private network (VPN) or some other system to limit access to only those parties that are entitled to such access. Other configurations are of network are considered within the scope of the present invention, as are the usages of various commonly known telecommunications devices such as computer terminals, switches, routers, servers, and their attendant software applications and operating systems.

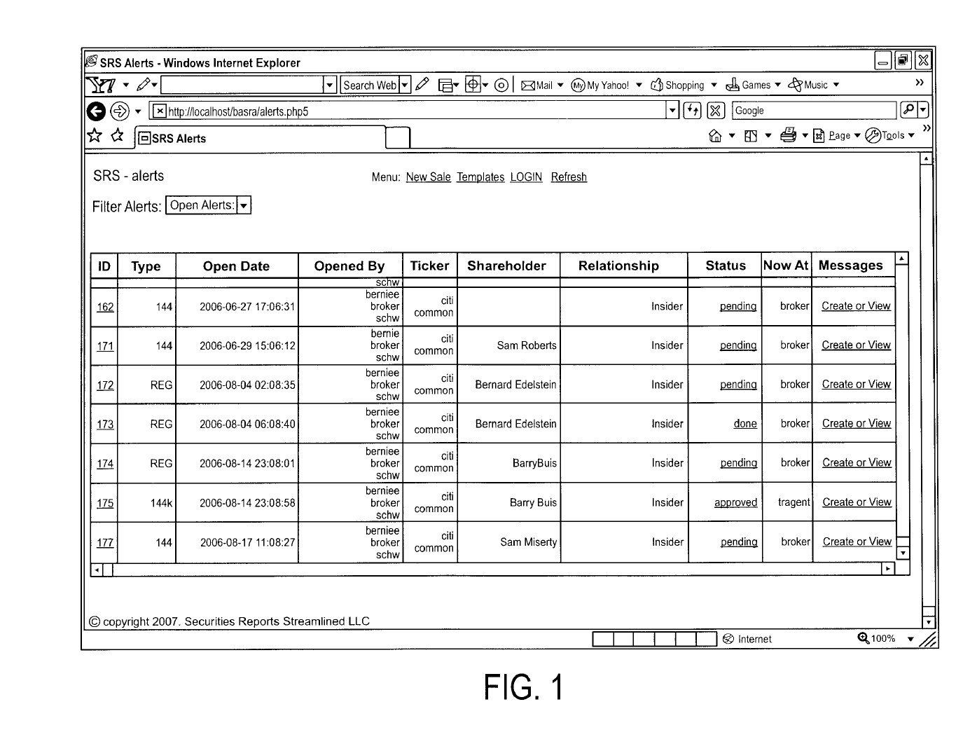

As described above, one aspect of the present invention is directed to an automated web based application for the sale of securities. As such it is designed to be accessed from a user's computer terminal Sample screen shots of such an application can be seen in FIGS. 1-7.

Organizational work flow support is centered with the alerts dashboard as shown in FIG. 1. The alerts dashboard brings together all outstanding activities of all participants in a transaction with summary, status and integrated messaging facilities. Email alerts are in the background. Activities are tracked rigorously, with audit trails of time-stamped milestones displayed at a click of the status link. The goal is to disseminate information broadly to appropriate participants and prevent neglect of required actions.

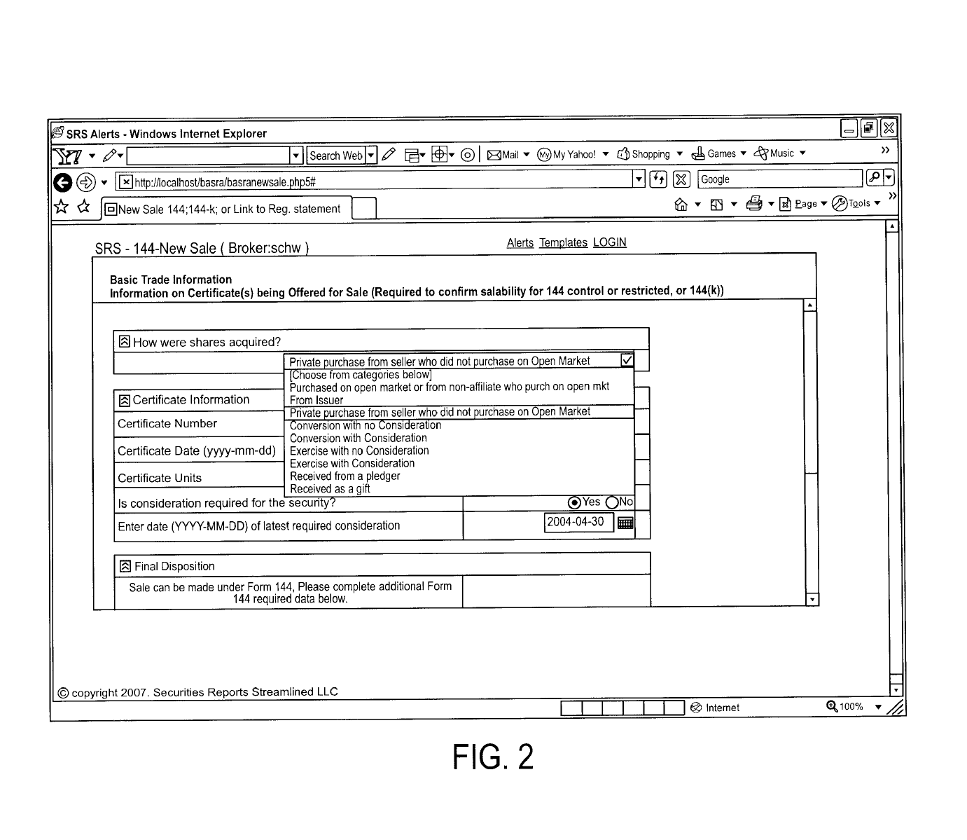

FIG. 2 shows a wizard, such as might be seen by a broker in step 114 above. The wizard may include pull down menus from which to select actions as well as fields that can be manually entered or populated by the SRSrun database.

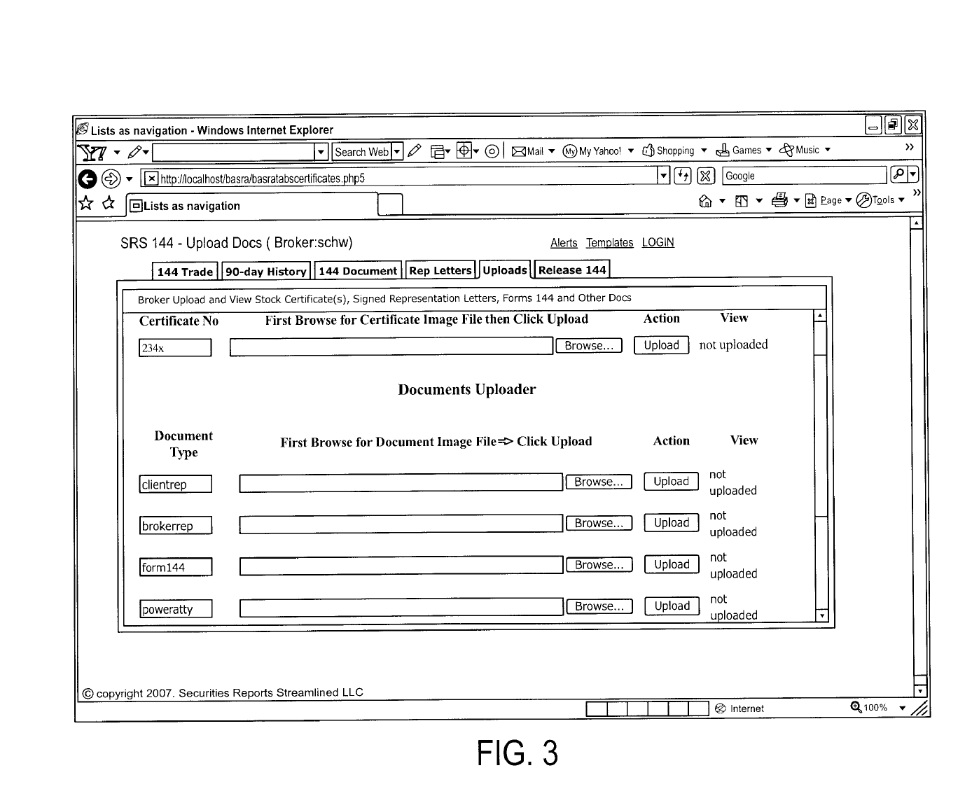

Documentation as well as messages are tagged and retrievable automatically by the relevant transaction numbers. FIG. 3 shows a screen in which all documents uploaded for a particularly transaction can be stored, viewed, and retrieved from with a mouse click. Thus documents are not simply routed to a email inbox of one of the participants, but are maintained and stored centrally for all participants to access as necessary.

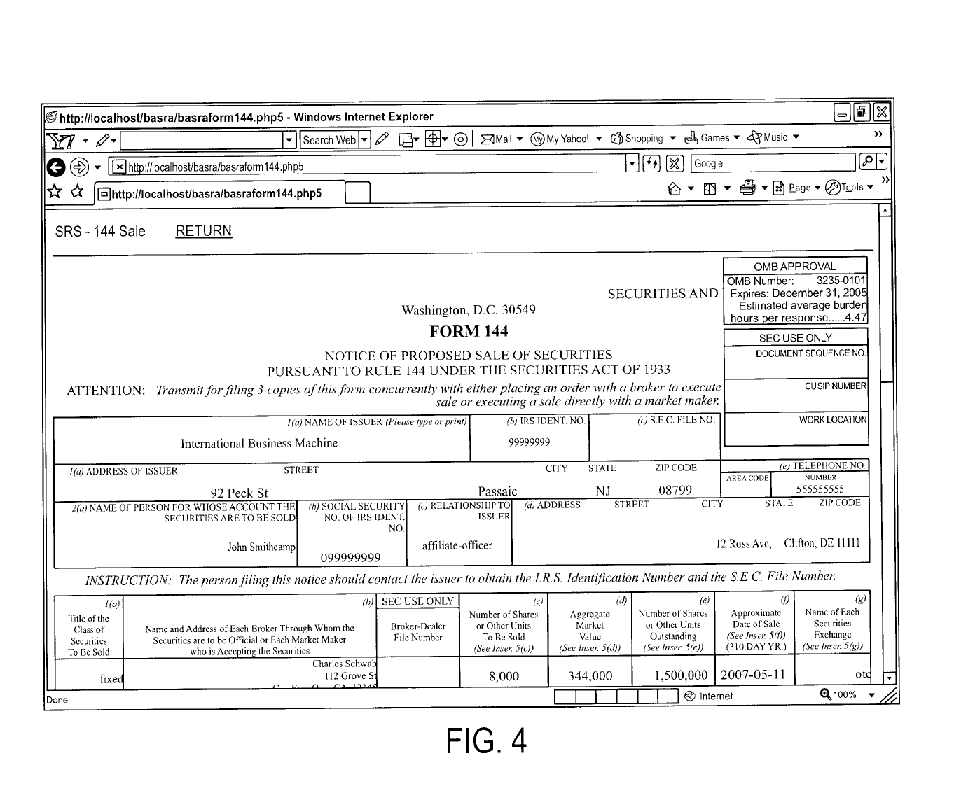

FIG. 4 shows a sample Rule 144 form that can be generated using the system. Office clerical procedures are replete with methodologies that entail transposition of numbers from one document to another, or copying and then selectively deleting a previous document's data. SRSrun eliminates much of this tedious and error prone methodology by propagating forms from the data that is entered for the transaction or from reference information on central files. The data might be drawn by web methods that reach out to external sources or utilize the SRSrun databases to utilize the same, and correct, information again and again to reduce effort and errors.

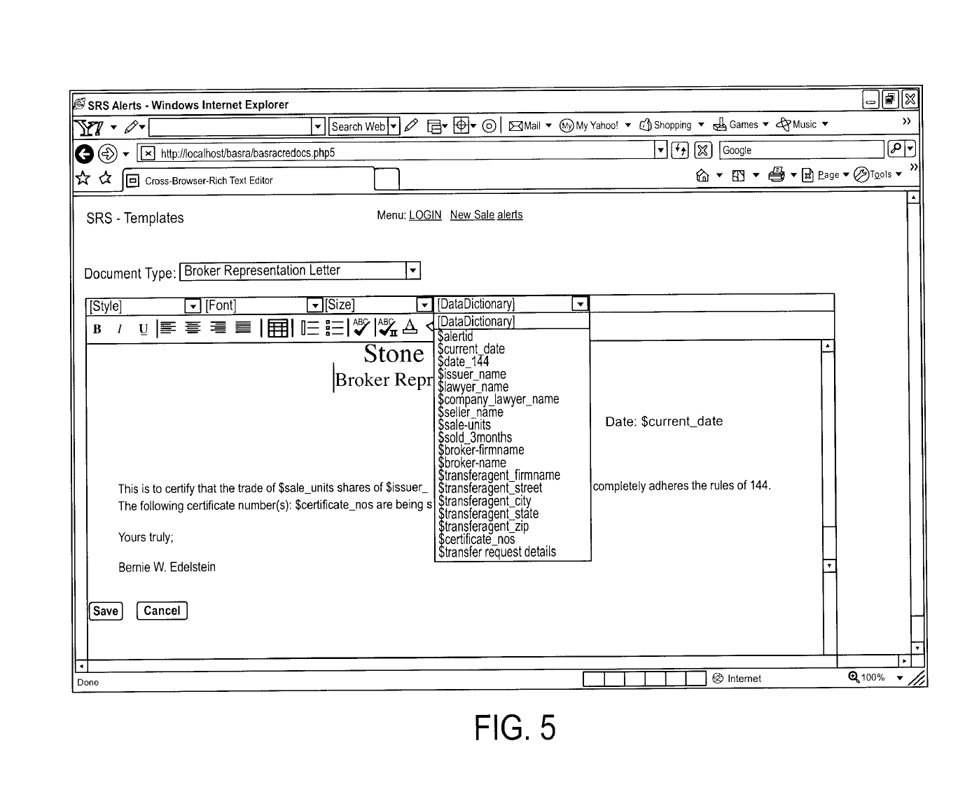

Various representation and legal opinion letters are also generated, with the relevant data reliably entered using templates as shown in FIG. 5. This screen also shows the utilization of a built-in word processor for the creation/modification of templates at various levels. For example, the legal opinion for a 144 might be common across the board for all sales, but participants often need to adapt their own standards to the process. The present invention supports this effort.

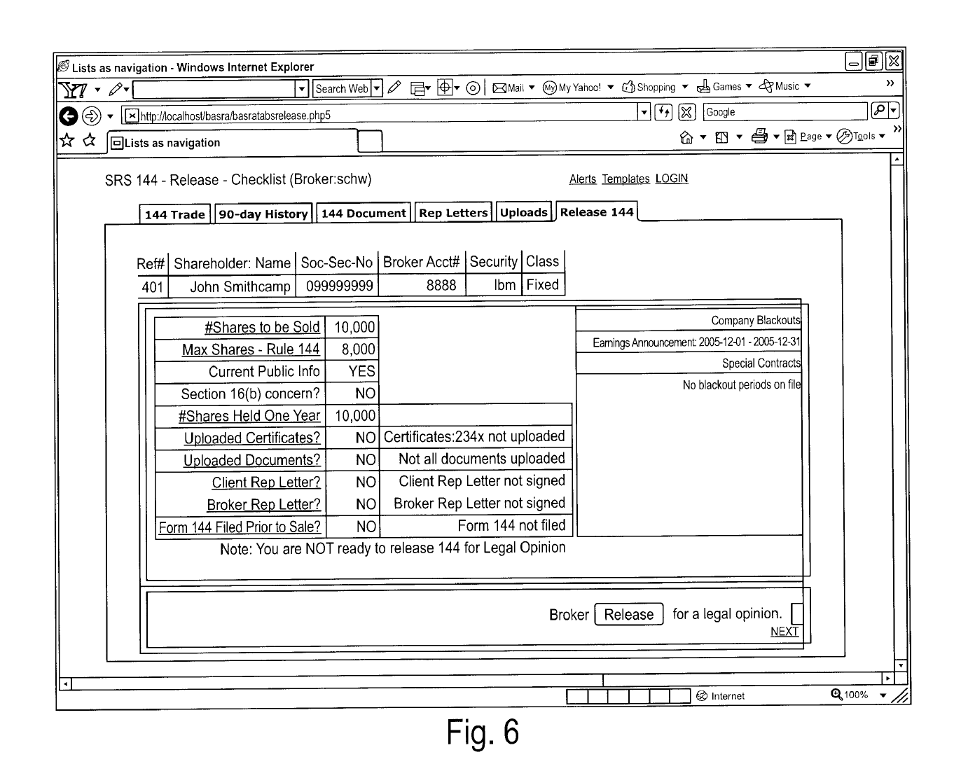

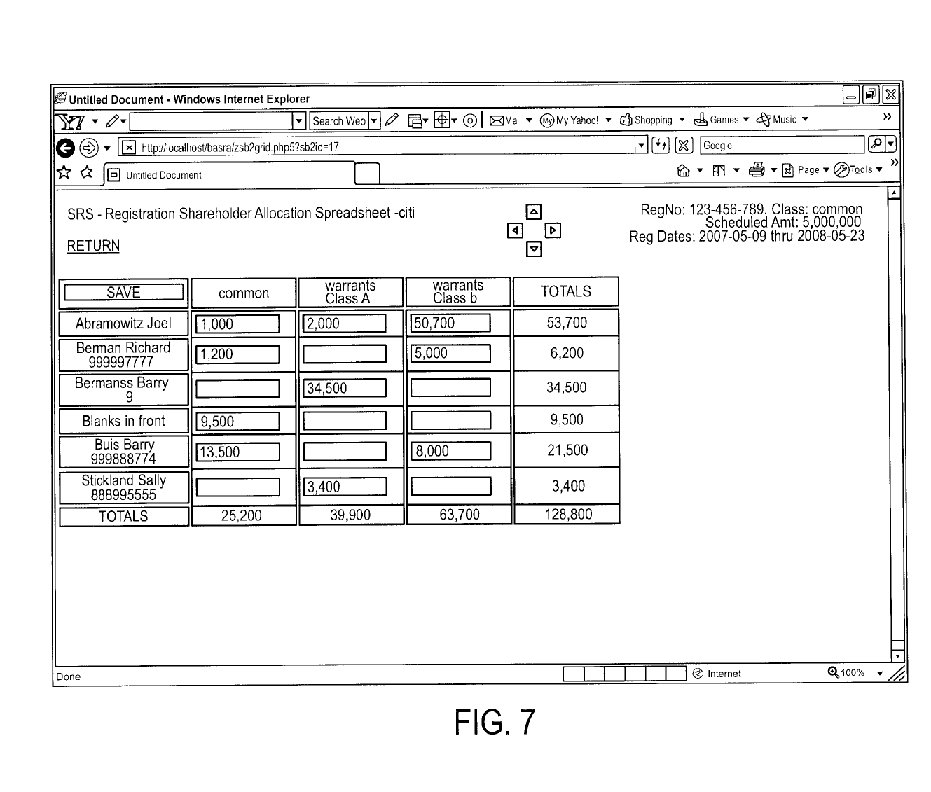

FIG. 6 provides an illustration of the format seen by a lawyer of a checklist they can use in reviewing a legal opinion prepared by SRSrun before he or she electronically releases the request for a 144 sale. And FIG. 7 shows an allocation matrix or spreadsheet of the type discussed above for SB2 registration shareholders and can be used to capture and maintain conversions and legend removals for holders of various classes of securities.

Workflow for tracking activities that move between various parties to a transaction reduce or eliminate unanswered phone calls and help disseminate up-to-date status information to clients and participants. Electronic signature approvals greatly speed the process and control. Audit trails of the above add rigor and accountability. The present invention retains the capacity for customization that is requisite in the securities, legal and corporate environment.

In addition to process support as illustrated above, SRSrun provides in-depth support to the participant product. It adapts complex legal formulations to a wizard format in a web browser, without usurping the participant's opportunity to apply judgment. As shown in FIG. 2 the wizard methodology provides the ability to tack the 144 analysis. It accomplishes this by combining rich data integration, modern web-technology and in-depth expert knowledge of the legal process. As described above with respect to FIGS. 9a-91 some of the primary issues dealt with by SRSrun and its internal wizards are:
(1) Whether the sale is supportable by a registration statement, 144, 144-k, or none
(2) Whether a sale involves control stock or restricted stock.
(3) Whether the trade is supportable in light of the corporation's record of regulatory reporting (current public information) and imposed blackout periods, or 16(b) rules.
(4) Whether the seller is an affiliate or not; and
(5) Volume limitations—outstanding shares and average trading.

Thus all shareholder transactions and amendments to 144 are captured once and are immediately applied to the formulas as required by subsequent transactions providing every participant in the process immediate access to information regarding the sale of securities.

Further, at the corporate level the present invention enables the complex tracking of shareholder registrations, conversions and transfers, and myriad reporting with innovative automation as described above.

According to one aspect of the present invention, a corporate financial work station is tied to integration of various processes. For example 144 and registration sales are inter-connectable with other types of forms, which may be required for reports on holdings and stock sales by insiders, etc., and other arrangements.

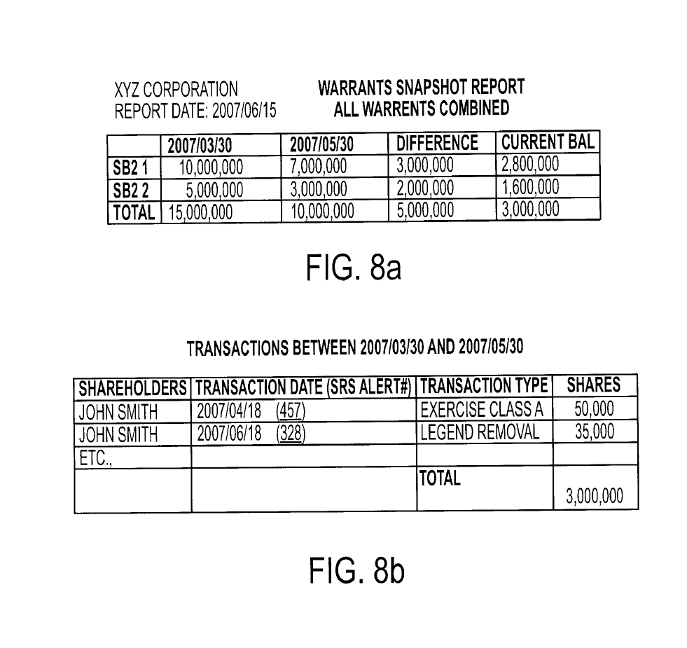

FIGS. 8a and b illustrate two of many reports that can be dynamically generated for senior management from SRSrun. A drill down report such as that shown in FIG. 8a displays shareholder transactions (i.e. exercises and legend removals) that reflect the change in period to period-end positions. FIG. 8b shows the drilling down to a further level by clicking for example on the “difference” column. Thus SRSrun provides a central information store for key shareholder data appropriate to information needs at the corporate level.

Another aspect of the present invention is directed to the reports that can be generated at various levels of management given the system described above. Such reports and the “roll-up” process as described herein are applicable to almost any data intensive computer based system requiring reports at varying levels of oversight and management.

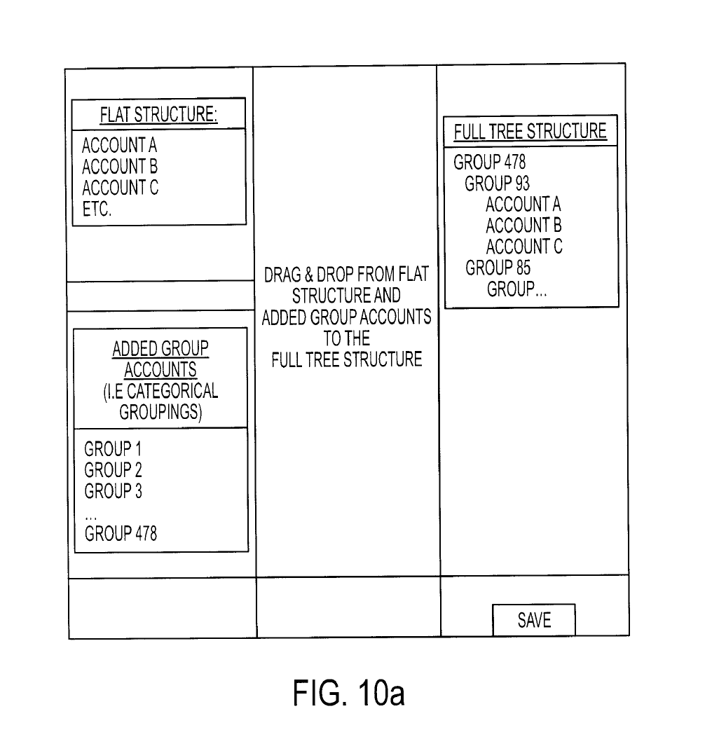

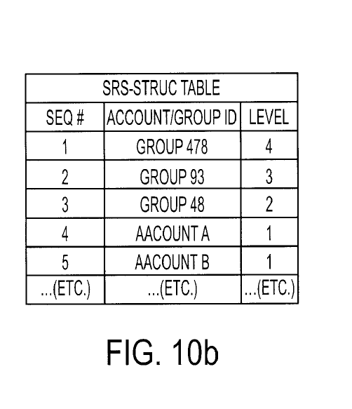

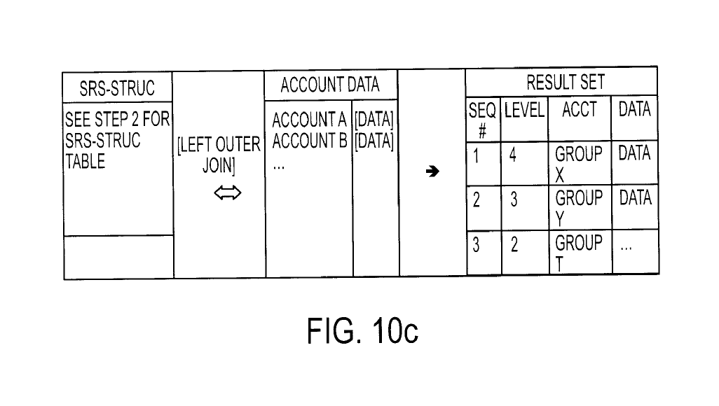

Typically, a report, for example for a single account such as Account A, B, or C as shown in FIG. 10a, is available for a user to review. This is often referred to as a flat report as it details the activities of just that single account. This may or may not be sufficient for an account holder to review their own account. However, for certain individuals, such as an account manager or a broker, who will have any number of accounts, the ability to group accounts together to create a pool of accounts can be very useful from the standpoint of ascertaining overall data for all of those accounts, identifying trends, ensuring compliance, etc. This aspect of the present invention is directed to a software application to be run on a computer having access to one or more databases, such as the SRSrun database described above, storing the underlying data and enabling the data to be grouped and re-grouped for further analysis.

In order to enable this grouping of data, such that it can be “rolled-up” to a next level of data for analysis, the present invention allows a user such as an account manager or broker or an individual having multiple accounts, to drag and drop the accounts to place them in an order. This can be seen for example in the upper right hand corner of the FIG. 10 showing accounts A, B, and C under Group 93, which is itself a member of Group 478. Any number of hierarchical groupings can be made, and given the right parameters, an account could be a member of several different Groups. This hierarchical grouping is called a tree.

Once the tree is formed, the application of the present invention builds a SQL database table, which shows the Level of the data, indicates that Group ID, and provides a Sequence number. This is shown in Step 10b.

Once established as a database, usage of SQL (Left-Outer-Join) functionality, allows the groupings of data into a table having the structure selected in FIG. 10a. This table includes all of the individual groupings of data available in each of the accounts selected. By using the Left-Outer-Join function, where data is not found in one of the accounts a 0 or Null is inserted. The program then using SQL finalizes the table showing the desired number of “group by” levels.

The result is a table, typically shown on a computer screen that allows for speedy transition between various Groups and allows review of data on every level of the table and for each of the data types available in any of the Groups.

Thus if an account manager wishes to see the total value or other factor of his accounts he can roll them up and view total values. At the same time using the tree'd approach he can also drill down into individual accounts or data types for further analyses.

This system can be usefully used in systems such as the Rule 144 sales described elsewhere in the application, to monitor how transactions are being handled, where delays are developing, ensure regulatory compliance and other features. All of these can be viewed at a glance by corporate management by rolling the data up to an appropriate level of their review, but at the same time, data can be rolled down to monitor an individual sale.

One of skill in the art will readily appreciate that this creation of tree'd data structures and the ability to roll-up underlying data into ever higher levels of data groupings for review and report generation can be employed in almost any context requiring the analysis of data at varying levels of management. An obvious usage for such a system is in corporate payroll systems where each group has a need to assess payroll, a business unit may have a need to asses payroll across multiple groups, a division may have a need to analyze data across multiple business units, and a final corporate head unit may have a need to access data across all divisions. By using the system described herein, such a corporation can access the data at the appropriate level for its own review, and simultaneously have the option of rolling-up or down the data in the tree'd structure for review of either more specific data, or more generalized big picture data. Other applications requiring similar functionality can be appreciated by one of skill in the art.

We claim:

1. A computer program stored on a computer readable recording medium and operable over a computer network for the sale of securities, the computer program performing the steps of:
receiving a request for sale from a shareholder via a broker;
determining whether there is a registration statement active,
if there is a registration statement active, the computer program provides an allocation matrix for review by the broker and generates a broker representation letter;
forwarding the broker representation letter for legal review and generating a legal opinion letter;
forwarding the legal opinion letter and broker representation letter and other transaction documents to a transfer agent for review;
processing by the transfer agent and delivering certificates to the broker, wherein said transfer agent updates the information in the allocation matrix; and
completing by the broker.

2. A computer program stored on a computer readable recording medium and operable over a computer network for the sale of securities, the computer program performing the steps of:
receiving a request for sale from a shareholder via a broker;
determining whether there is a registration statement active,
if there is no registration statement active, determining if the shareholder had affiliate status;
if there is no affiliate status, determining if the shareholder has held the securities for two or more years;
if the shareholder has held the securities for two or more years, the broker arranges to receive the certificates and uploads them to the a database accessible to the computer program and releases them for legal;
generating a 144 legal review letter authorizing sale and releasing the letter and sale documents to a transfer agent;
review by the transfer agent and removal of any legend on the securities; and
delivering the securities to the broker for finalizing sale.

3. A computer program stored on a computer readable recording medium and operable over a computer network for the sale of securities, the computer program performing the steps of:
receiving a request for sale from a shareholder via a broker;
determining whether there is a registration statement active,
if there is no registration statement active, determining if the shareholder had affiliate status;
if there is no affiliate status, or if the shareholder has not held the securities for two or more years, calculating a maximum number of shares the shareholder can sell;
designating lots of the security to be included in the sale;
preparing broker representation letter, shareholder representation letter and form 144 and releasing these documents and other documents for the sale for legal review;
generating a legal opinion letter and releasing it and the documents for the sale to a transfer agent;
removing, by the transfer agent, any legend on the securities and delivering the securities to the broker.

4. A computer program stored on a computer readable recording medium for the organization of financial data the program enabling the performance of steps comprising:
providing a user interface, wherein the user has access to multiple layers of hierarchical data from a multiple sources;
selecting by a user a first layer of data and grouping similar data at that level;
selecting by a user a second level of data and placing by the user the first layer of data under the second layer;
generating a database from said first and second layers of data;
grouping desired portions of said first and second layers of data together in a predetermined fashion to create a multi-layered tree of data, wherein each successive layer of data provides of summary of all the data residing beneath that layer;
enabling the generation of reports for each layer of data in the data tree.

5. A computer program stored on a readable recording medium for the creation of new securities, said program performing the steps of:
enabling a user to create a form requesting creation of the new securities;
forwarding the form to legal for review,
generation of a legal review letter;
forwarding the form and the legal review letter to a transfer agent, and if approved updating the computer program to reflect the issuance of the new securities.
